(19) United States
(12) Patent Application Publication
(10) Pub. No.: US 2007/0228930 A1
(43) Pub. Date: Oct. 4, 2007

(54) Field emission backlight, display apparatus using the same and a method of manufacturing the same

(76) Inventors: Hyeong-Suk Yoo, Gyeonggi-do (KR); Seung-Ki Joo, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/713,203

(22) Filed: Mar. 2, 2007

(30) Foreign Application Priority Data
Mar. 3, 2006 (KR) 2006-20256

(51) Int. Cl. H01J 1/62; H01J 63/04

(52) U.S. Cl. 313/495; 313/497

(57) ABSTRACT

A field emission backlight for a display device includes upper and lower substrates. The upper substrate includes an upper transparent substrate, a transparent electrode, and a fluorescent part. The lower substrate includes a lower transparent substrate having a receiving groove, a first electrode part, a second electrode part, and an electron-emitting part. The first electrode part is formed on an upper surface of the lower transparent substrate and the second electrode part is formed on a bottom surface of the receiving groove, so that the gap between the first and second electrode parts can be reduced below that conventionally required. This, in turn, enables the level of a voltage applied between the first and the second electrode parts to be reduced, and a corresponding reduction in the manufacturing cost of a field emission backlight to be achieved.

### RELATED APPLICATIONS

This application claims priority of Korean Patent Application No. 2006-20256, filed Mar. 3, 2006, the entire disclosure of which is incorporated herein by reference.

### BACKGROUND

This disclosure relates to making field emission backlights for display devices, such as liquid crystal displays (LCDs), and more particularly, to methods for making field emission backlights that substantially reduce their manufacturing costs.

Liquid crystal displays (LCDs) generally include an LCD panel that displays an image by using the optical transmittance of a layer of liquid crystal material disposed in the panel and the light produced by a backlight assembly disposed behind the panel.

Backlight assemblies can be classified according to the type of light sources used therein, e.g., cold cathode fluorescent lamp (CCFL) backlights, external electrode fluorescent lamp (EEFL) backlights, light emitting diode (LED) backlights, and so on.

A recent innovation in the field of backlights has been the development of field emission backlights. A field emission backlight generates light through an electric field applied between two substrates. A conventional field emission backlight includes upper and lower substrates. The upper substrate includes a transparent electrode and a fluorescent material. The lower substrate includes an electrode part and an electron-emitting part. When a high voltage is applied between the transparent electrode of the upper substrate and the electrode part of the lower substrate, an electric field is generated and electrons are emitted from the electron-emitting part. The emitted electrons excite the fluorescent material on the upper substrate and thereby produce light. However, one of the problems with conventional field emission backlights is that they consume a large amount of electrical power because of the high voltage that needs to be applied between the transparent electrode and the electrode part.

More recently, field emission backlights having a triode structure have been developed in an effort to resolve the above problem of conventional field emission backlights. The triode structured field emission backlight generates light using a relatively low voltage. The triode structured field emission backlight includes an anode, a cathode and a gate electrode. When a relatively low voltage is applied between the cathode and the gate electrode, and electrons are emitted from the cathode, the electrons advance toward the anode and collide with a fluorescent material so that light is generated.

Triode structured field emission backlights also have another structure that has been developed to improve the uniformity of brightness of the light they produce. The triode structured field emission backlight includes the above cathode and gate electrode that are arranged in an alternating in the same plane. However, the cost of the driving circuit in triode field emission backlights incorporating such a structure is increased because a relatively high voltage, e.g., 400V˜600V, must be applied between the cathode and the gate electrode to generate light of sufficient brightness.

### BRIEF SUMMARY

In accordance with the exemplary embodiments thereof described herein, the present invention provides field emission backlights for display devices and methods for manufacturing them at a substantially reduced cost by enabling the voltage applied between the cathode and the gate electrode to be reduced, as well as to display devices incorporating the novel field emission backlights.

In one exemplary embodiment thereof, a field emission backlight includes upper and lower substrates. The upper substrate includes an upper transparent substrate, a transparent electrode formed on the upper transparent substrate, and a fluorescent part formed on the transparent electrode.

The lower substrate includes a lower transparent substrate having a receiving groove formed in an upper surface being disposed in facing opposition to the upper substrate, a first electrode part formed on the upper surface, a second electrode part formed on a bottom surface of the receiving groove, and an electron-emitting part formed on an upper surface of at least one of the first and second electrode parts. The upper surface of the lower substrate is disposed below and in facing opposition with the upper substrate. The first and second electrode parts are spaced apart from each other by a selected. The electron-emitting part emits electrons in response to an electric field generated between the first and second electrode parts.

An exemplary embodiment of a field emission display apparatus includes a field emission backlight producing light, and a display panel disposed above the field emission backlight. The display panel displays an image by means of the light produced by the backlight.

The field emission backlight of the display includes field emission backlight includes upper and lower substrates. The upper substrate includes an upper transparent substrate, a transparent electrode formed on the upper transparent substrate, and a fluorescent part formed on the transparent electrode. The lower substrate includes a lower transparent substrate having a receiving groove formed in an upper surface being disposed in facing opposition to the upper substrate, a first electrode part formed on the upper surface, a second electrode part formed on a bottom surface of the receiving groove, and an electron-emitting part formed on an upper surface of at least one of the first and second electrode parts. The upper surface of the lower substrate is disposed below and in facing opposition with the upper substrate. The first and second electrode parts are spaced apart from each other by a selected. The electron-emitting part emits electrons in response to an electric field generated between the first and second electrode parts.

An exemplary embodiment of method for manufacturing a field emission backlight includes forming a first metal layer on a upper surface of a lower transparent substrate, forming and patterning a first photoresist layer on the first metal layer, etching a portion of the first metal layer using the patterned first photoresist layer as a mask, forming a receiving groove by etching a portion of the lower transparent substrate using the etched first metal layer as a mask, forming a second metal layer on the patterned first photoresist layer and a bottom surface of the receiving groove, removing the patterned first photoresist layer, forming an electron-emitting part on the first and the second metal layers to form a lower substrate, forming an upper substrate, including an upper transparent substrate, a transparent electrode formed on the upper transparent substrate, and a fluorescent part formed on the transparent electrode, and combining the upper substrate and the lower substrate to form a field emission backlight.

In accordance with the exemplary embodiments described herein, the gap between the first and second electrode parts of the lower substrate is substantially reduced relative to that in conventional field emission backlights because the first electrode part is formed at the upper surface of the lower transparent substrate and the second electrode part is formed at the bottom surface of the receiving groove. This enables the voltage applied between the first and the second electrode parts to reduced, thereby enabling the cost of the components of a driving circuit that produces the voltage to be reduced and resulting in an overall reduction in the manufacturing cost of the backlight.

A better understanding of the above and many other features and advantages of the field emission backlights and the methods for making them of the present invention may be obtained from a consideration of the detailed description of some exemplary embodiments thereof below, particularly if such consideration is made in conjunction with the appended drawings, wherein like reference numerals are used to identify like elements illustrated in one or more of the figures thereof.

### BRIEF DESCRIPTION OF THE DRAWINGS

FIG. 1 is an exploded perspective view of an exemplary embodiment of a field emission backlight for a display device in accordance with the present invention;

FIG. 2 is a partial cross-sectional view of the exemplary backlight as seen along the lines of the section I-I′ taken in FIG. 1;

FIG. 3 is an enlarged cross-sectional view of an outlined portion ‘A’ of the backlight of FIG. 2;

FIG. 4 is a schematic cross-sectional view of an exemplary embodiment of a display apparatus with a field emission backlight in accordance with an exemplary embodiment of the present invention;

FIGS. 5A to 5H are partial cross-sectional views respectively illustrating sequential processes involved in an exemplary embodiment of a method for manufacturing a field emission backlight in accordance with the present invention;

FIGS. 6A to 6C are partial cross-sectional views respectively illustrating sequential processes of a second exemplary embodiment of a method for manufacturing a field emission backlight in accordance with the present invention; and,

FIGS. 7A to 7D are partial cross-sectional views respectively illustrating sequential processes of a third exemplary embodiment of a method for manufacturing a field emission backlight in accordance with the present invention.

### DETAILED DESCRIPTION

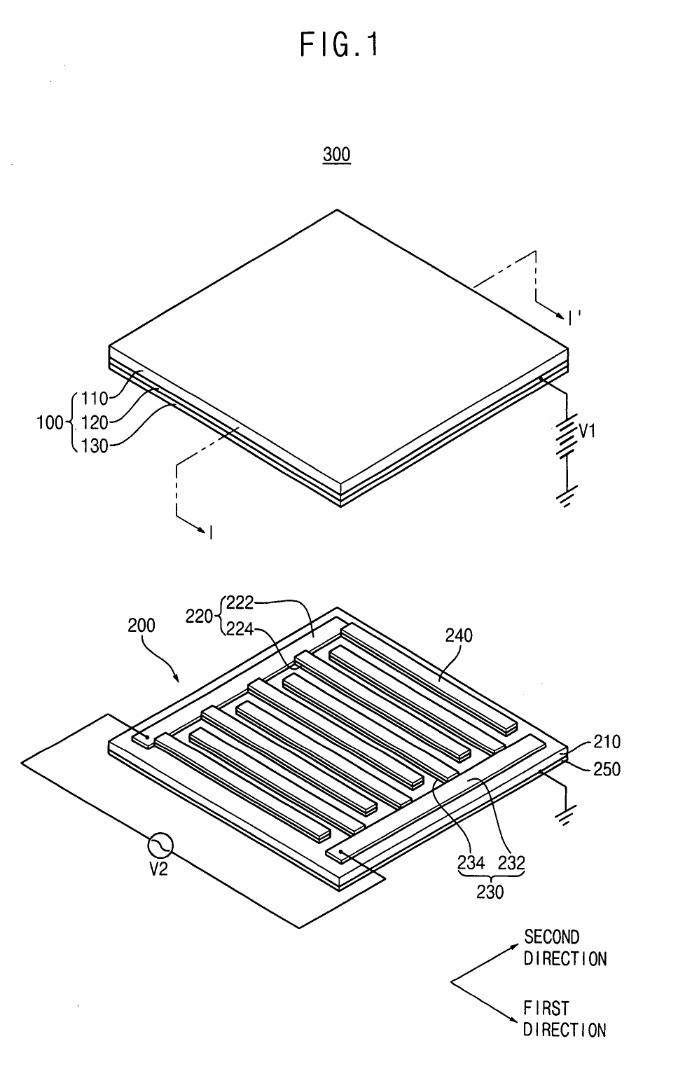

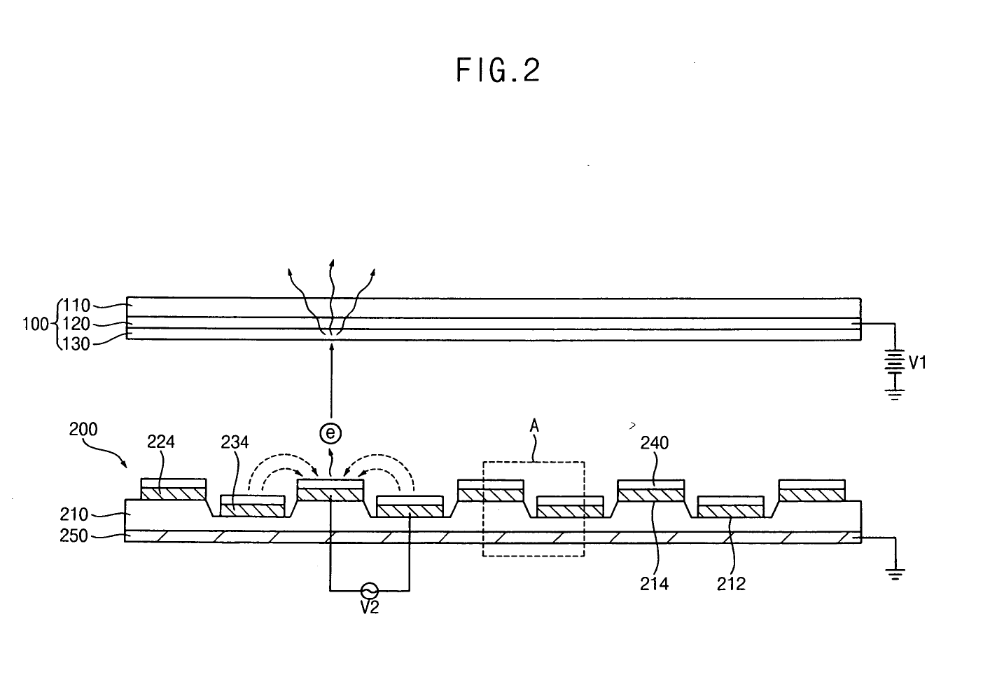

FIG. 1 is an exploded perspective view of an exemplary embodiment of a field emission backlight for a display apparatus in accordance with the present invention, and FIG. 2 is a partial cross-sectional view of the exemplary backlight as seen along the lines of the section I-I′ taken in FIG. 1;

Referring to FIGS. 1 and 2, a field emission backlight 300 includes an upper substrate 100 and a lower substrate 200. The field emission backlight 300 generates light through an electric field applied between the upper substrate 100 and the lower substrate 200. The generated light exits upwardly from the field emission backlight 100.

The upper substrate 100 includes an upper transparent substrate 110, a transparent electrode 120 and a fluorescent part 130. The upper transparent substrate 110 is plate shaped and comprises a transparent material, for example, glass, quartz or a transparent plastic. Preferably, the upper transparent substrate 110 comprises glass.

The transparent electrode 120 is formed, for example, by a vapor deposition process, on a lower surface of the upper transparent substrate 110. The transparent electrode 120 comprises a transparent conductive material, for example, indium tin oxide (ITO), indium zinc oxide (IZO), amorphous indium tin oxide (a-ITO), or the like. The transparent electrode 120 is electrically coupled with an external voltage supply that applies a direct current (DC) voltage V1 to it. The DC voltage V1 is, for example, in a range of from about 5 kilovolts (kV) to about 15 kV, and preferably, is in a range of from about 8 kV to about 10 kV.

The fluorescent part 130 is formed on the lower surface of the transparent electrode 120. The fluorescent part 130 generates light by means of electrons emitted from the lower substrate 200. The electrons emitted from the lower substrate 200 collide with the fluorescent part 130 to excite the fluorescent part 130, and when the excited fluorescent part 130 relaxes from the excitation, light radiates from it.

The lower substrate 200 is disposed with its upper surface facing upward toward the upper substrate 100. The lower substrate 200 includes a lower transparent substrate 210, a first electrode part 220, a second electrode part 230, an electron-emitting part 240 and a reflecting part 250.

The lower transparent substrate 210 is plate shaped and comprises a transparent material, for example, glass, quartz or a transparent plastic, and preferably, is glass.

As illustrated in FIG. 2, a receiving groove 212 having a selected depth is formed in an upper surface of the lower transparent substrate 210, which is disposed in facing opposition to the upper substrate 100. Hereinafter, a “protruding surface 214” is defined as an upper surface of the lower transparent substrate 210 at which the receiving groove 212 is not formed. The “protruding” of the protruding surface 214 means that the protruding surface 214 relatively protrudes with respect to the receiving groove 212. That is, the protruding surface 214 may be just the upper surface of the lower transparent substrate 210, and does not necessarily protrude from the lower transparent substrate 210.

As illustrated in FIG. 1, a first electrode part 220 is formed on the protruding surface 214 of the lower transparent substrate 210, a second electrode part 230 is formed on a bottom surface of the receiving groove 212, and the first and second electrode parts 220 and 230 are spaced apart from each other by a selected distance.

As illustrated in FIGS. 1 and 2, the first electrode part 220 includes an elongated first body electrode 222 and a plurality of elongated first branch electrodes 224. The first body electrode 222 is disposed at a first side of the lower transparent substrate 210 and extends in a second direction. The first branch electrodes 224 are electrically connected to the first body electrode 222, extend generally perpendicularly from it and toward an opposite second side of the substrate, and are arranged substantially parallel to each other.

The second electrode part 230 includes an elongated second body electrode 232 and a plurality of elongated second branch electrodes 234. The second body electrode 232 is formed at the second side of the lower transparent substrate 210 and extends generally parallel to it and the first body electrode 222. The second branch electrodes 234 are electrically connected to the second body electrode, extend generally perpendicularly from it and toward the first side of the substrate, are arranged substantially parallel to each other, and are interleaved between the first branch electrodes 224. A gap is provided between the first and second branch electrodes 224 and 234 of from about 5 micrometers (μm) to about 15 μm, and preferably, of about 10 μm.

In the exemplary embodiment illustrated, the first electrode part 220 is formed on the protruding surface 214 of the lower transparent substrate 210, whereas, the second electrode part 230 is formed on the bottom surface of the receiving groove 212, and accordingly, the shape of the receiving groove 212 corresponds to that of the second electrode part 230.

A relatively low voltage is applied between the first and second electrode parts 220 and 230. The voltage applied is an alternating current (AC) voltage V2. For this purpose, an external voltage supply is electrically coupled to the first body electrode 222 of the first electrode part 220 and the second body electrode 232 of the second electrode part 230, and applies the alternating current voltage V2 to the first and the second electrodes 222 and 232. The alternating current voltage V2 may be, for example, in a range of from about 10 volts (V) to about 100 V, and preferably, is in a range of from about 40 V to about 60 V.

The electron-emitting part 240 is formed on at least one upper surface of either the first or the second electrode parts 220 and 230, and to increase brightness, may be formed on the upper surfaces of both the first and the second electrode parts 220 and 230. Accordingly, the electron-emitting part 240 may have elongated shapes corresponding to those of the underlying first and second electrode parts 220 and 230.

When an electric field is generated between the first and the second electrode parts 220 and 230, the electron-emitting part 240 emits electrons in response thereto. Thus, when the alternating current voltage V2 is applied to the first and second electrode parts 220 and 230, one electrode has a higher voltage and the other a lower voltage, and accordingly, an electric field is generated between them, resulting in the emission of electrons from the electron-emitting part 240. The intensity of the electric field may be in the range of from about 4 V/μm to about 6 V/μm.

The electrons emitted from the electron-emitting part 240 move toward the upper substrate 100 in response to the electric field generated between the upper substrate 100 and the lower substrate 200 by the direct current voltage V1.

As illustrated in FIGS. 1 and 2, the reflecting part 250 of the lower substrate 200 may include a metal. An external ground voltage is applied to the reflecting part 250. Accordingly, an electric potential difference equal to the direct current voltage V1 is generated, thereby generating an electric field between the upper and lower substrates 100 and 200.

Because the reflecting part 250 includes metal and the ground voltage is applied to it, the reflecting part 250 prevents external electromagnetic fields from penetrating into the field emission backlight 300, and accordingly, enables the stability of the electric fields inside the field emission backlight 300 to be preserved.

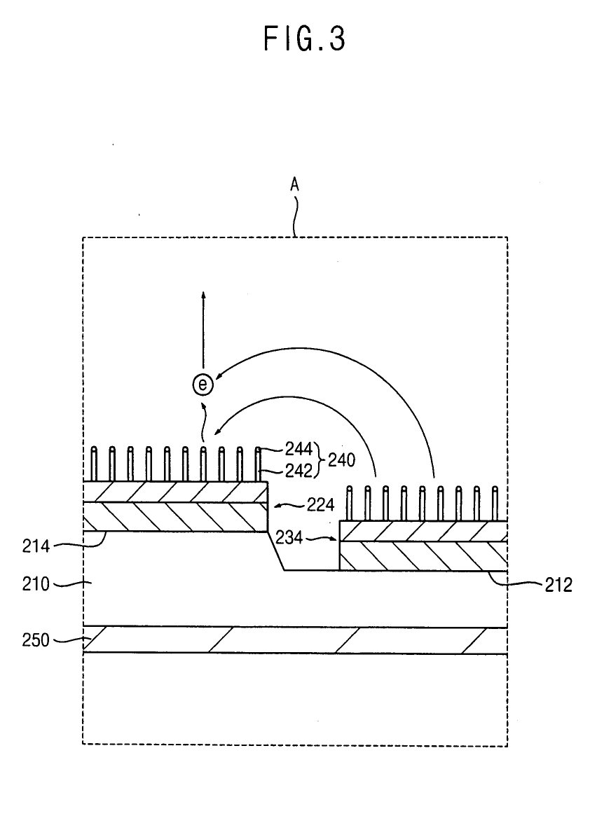

The first and second electrode parts 220 and 230 and the electron-emitting part 240 are described in more detail in connection with FIG. 3, which is an enlarged cross-sectional view of the outlined portion ‘A’ of the backlight of FIG. 2. Referring to FIG. 3, the first and second electrode parts 220 and 230 of the illustrated exemplary embodiment each have a duplex layer structure. For example, a bottom layer of the duplex layers comprises molybdenum-tungsten (MoW), and a top layer of the duplex layers comprises titanium (Ti). The electron-emitting part 240 includes a plurality of electron emitting protrusions 242 and a plurality of conductive balls 244 respectively disposed at the upper ends thereof.

The electron emitting protrusions 242 protrude substantially perpendicular to the first and second electrode parts 220 and 230, and comprise, for example, carbon nanotubes. The conductive balls 244 are disposed at an end portion of the electron emitting protrusions 242, and comprise, for example, nickel (Ni). Because of the presence of the electron emitting protrusions 242 and the conductive balls 244 on the electron-emitting part 240, the electron-emitting part 240 readily emits electrons as a result of the electric field formed between the first and second electrode parts 220 and 230.

Of importance, in the exemplary embodiment illustrated, the gap between the first and the second electrode parts 220 and 230 can be shortened because the first electrode part 220 is formed on the protruding surface 214 of the lower transparent substrate 210 and the second electrode part 230 is formed on the bottom surface of the receiving groove 212. As a result, the voltage applied between the first and second electrode parts 220 and 230 to generate the electrons can be correspondingly reduced.

In a conventional field emission backlight, electrodes corresponding to the first and second electrode parts 220 and 230 above are formed in the same layer, and hence, at the same level, and accordingly, are separated from each other by about 100 μm, due to limitations of the photo processes used to form them. However, the gap between the first and the second electrode parts 220 and 230 of the embodiment illustrated and described above can be reduced substantially below this because the first electrode part 220 is formed on and at the same level as the protruding surface 214 of the lower transparent substrate 210, whereas, the second electrode part 230 is formed on and at the same level as the bottom surface of the receiving groove 212.

When the gap between the first and the second electrode parts 220 and 230 is reduced, this enables the voltage that needs to be applied between the first and second electrode parts 220 and 230 to generate the electrons to be correspondingly reduced relative to that required in the conventional field emission backlight. This in turn, enables the cost of the components of a driving circuit that produces the voltage to be reduced, thereby resulting in a reduction in the manufacturing cost of the backlight.

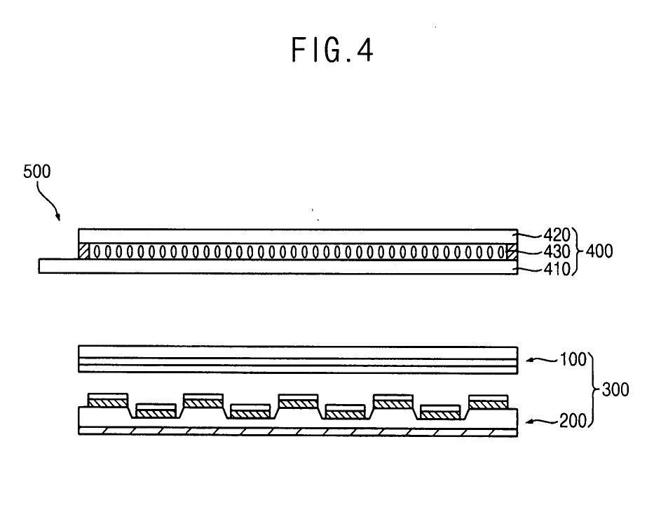

FIG. 4 is a schematic cross-sectional view of an exemplary embodiment of a display apparatus 500 incorporating a field emission backlight in accordance with an exemplary embodiment of the present invention. The structure of the field emission backlight of the display is substantially the same as that of the exemplary field emission backlight of FIGS. 1 to 3. Accordingly, in the following discussion, the same reference numerals are used to refer to the same or like parts, and further description of these elements is omitted for brevity.

Referring to FIG. 4, the exemplary field emission display apparatus 500 includes a field emission backlight 300 and a display panel 400. The field emission backlight 300 generates light by means of an electric field as described above and provides it to the display panel 400 disposed over it.

The display panel 400 is disposed over the field emission backlight 300 and displays images by using the light provided by the field emission backlight 300. The display panel 400 includes a first substrate 410, a second substrate 420 and a liquid crystal layer 430.

The first substrate 410 includes a plurality of pixel electrodes arranged in a rectangular matrix form, a plurality of thin film transistors (TFTs) that respectively applying a driving voltage to each of the pixel electrodes, and a plurality of signal lines that drive the TFTs.

The second substrate 420 is disposed in facing opposition to the first substrate 410, and includes a transparent conductive common electrode and a plurality of color filters, each disposed in facing opposition to a corresponding one of the pixel electrodes. In one exemplary embodiment, the color filters include transparent red, green and blue color filters.

A layer of a liquid crystal material 430 is interposed between the first and second substrates 410 and 420. The orientation of the molecules of the liquid crystal layer 430 is rearranged when an electric field is generated between the pixel electrodes and the common electrode. The rearranged molecules of the liquid crystal layer 430 adjust the optical transmittance of the panel to external light passing through it. The light, with an adjusted intensity, passes through respective ones of the color filters, so that images are displayed by the panel.

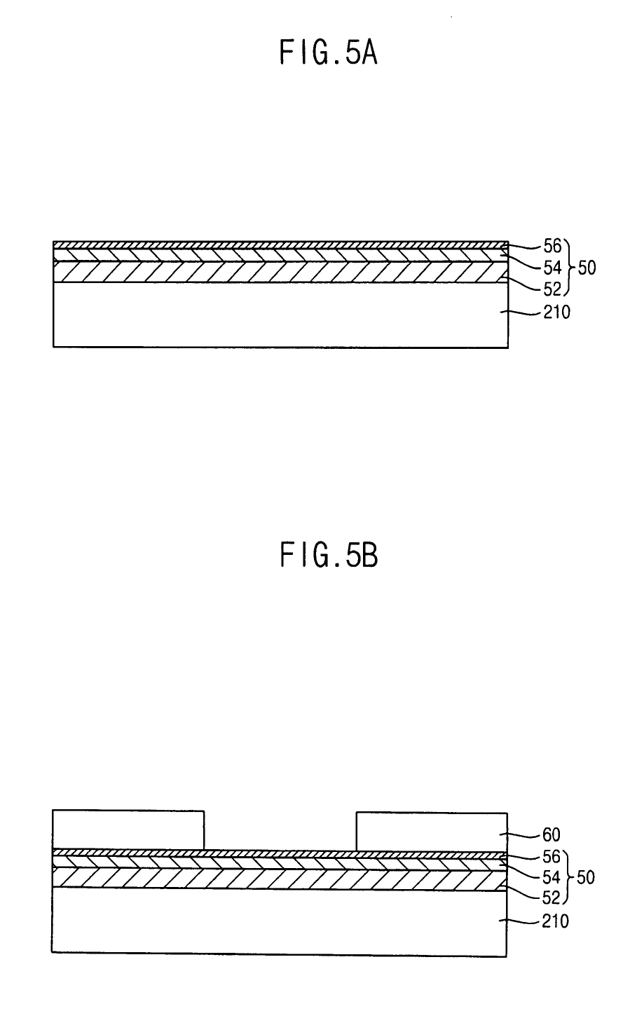

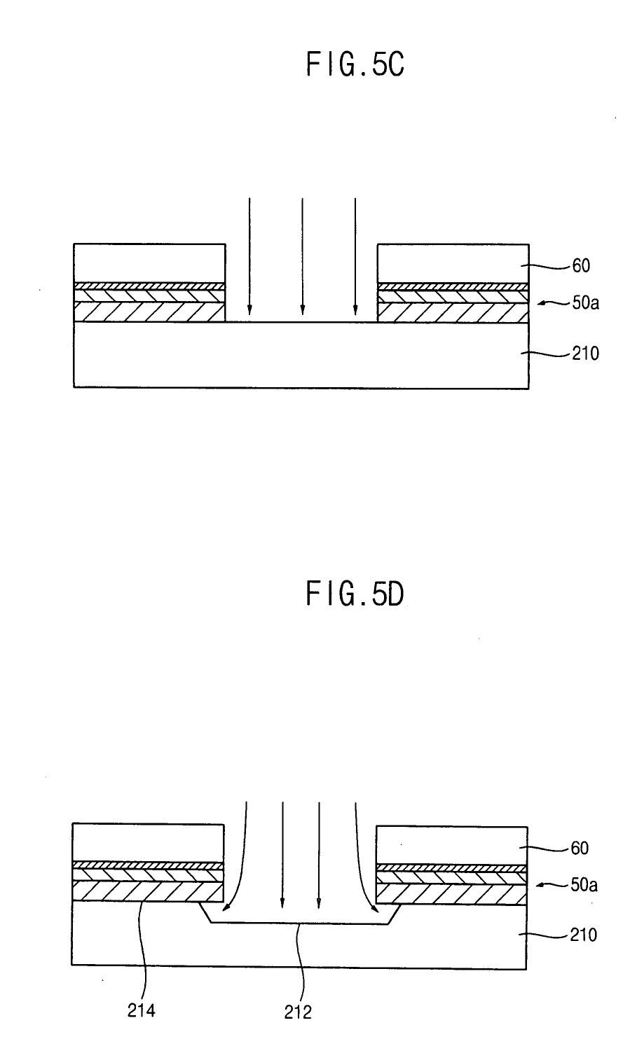

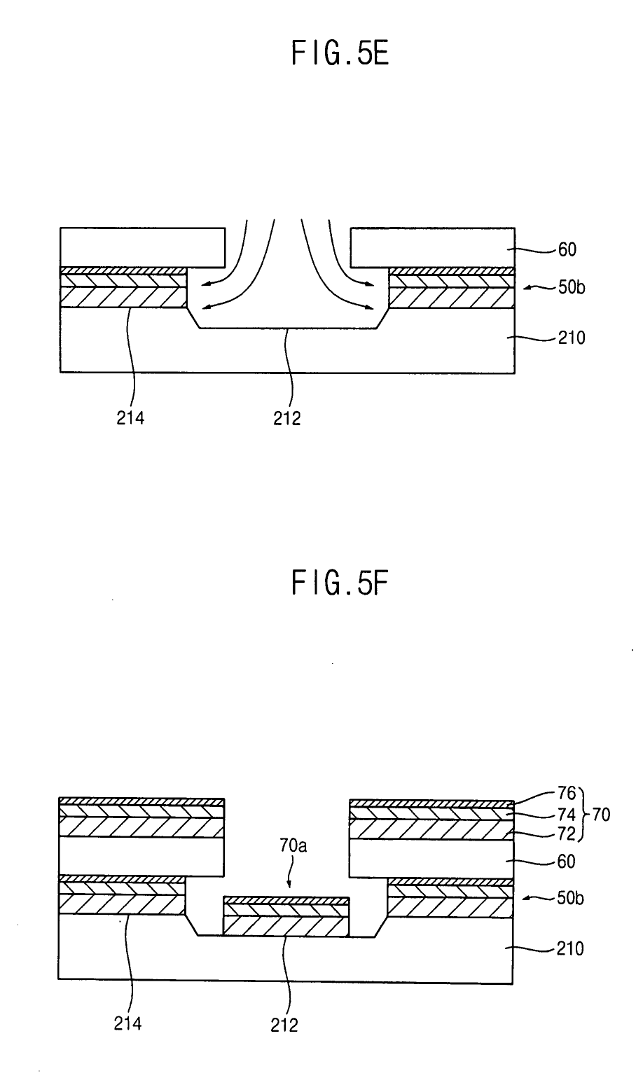

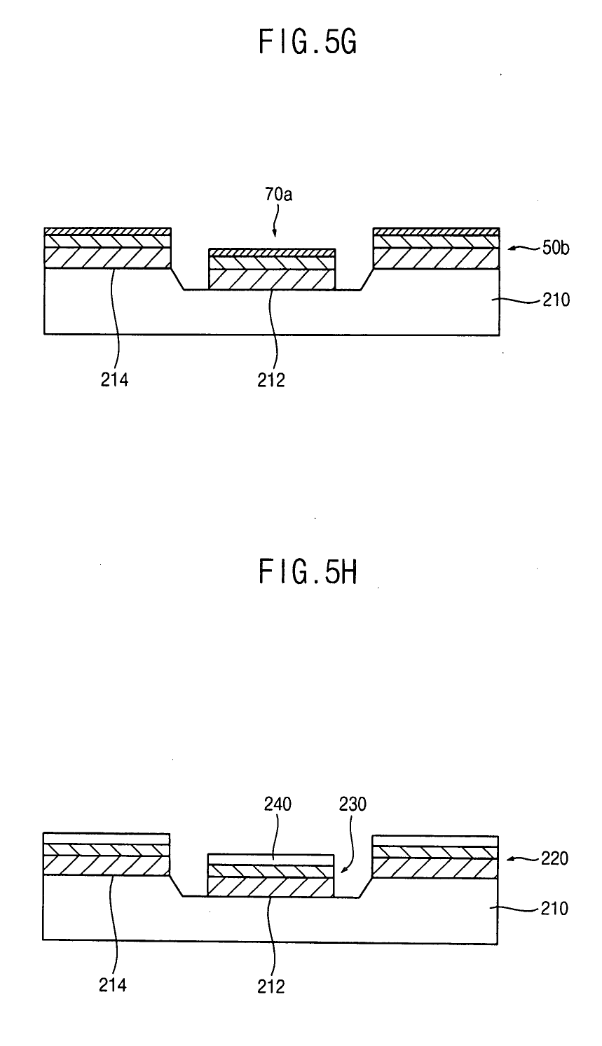

FIGS. 5A to 5H are partial cross-sectional views respectively illustrating sequential processes involved in an exemplary embodiment of a method for manufacturing a field emission backlight in accordance with the present invention.

FIG. 5A is a partial cross-sectional view illustrating a process for forming a first metal layer on an upper surface of a lower transparent substrate of the exemplary field emission backlight. Referring to FIG. 5A, a first metal layer 50 is formed on an upper surface of a lower transparent substrate 210. For example, the first metal layer 50 may be formed by a plasma chemical vapor deposition method or by a sputtering method. The first metal layer 50 may incorporate a triplex layer structure. For example, a bottom layer 52 of the first metal layer 50 may include molybdenum-tungsten (MoW), a middle layer 54 may include titanium (Ti), and a top layer 56 may include nickel (Ni).

FIG. 5B is a partial cross-sectional view illustrating a process of forming a patterned photoresist layer on the first metal layer. As illustrated in FIG. 5B, a photoresist layer 60 is formed over the entire upper surface of the first metal layer 50, and the photoresist layer 60 is then patterned with a photo process using a mask. In the particular embodiment illustrated, a portion of the photoresist layer 60 is removed by the photo process. The photoresist layer 60 may comprise either a positive photoresist or a negative photoresist.

FIG. 5C is a partial cross-sectional view illustrating a process of etching a portion of the first metal layer away using the patterned photoresist layer. Referring to FIG. 5C, a portion of the first metal layer 50 is etched away using the patterned photoresist layer 60 as a mask. In particular, a portion of the first metal layer 50 that is not covered by the photoresist layer 60 is removed with a metal etching solution. In the particular embodiment illustrated, the first metal layer 50 is etched along a substantially perpendicular direction down to an upper surface of a lower transparent substrate 210, so that the etched first metal layer 50 has a substantially the same shape as the patterned photoresist layer 60 when viewed in a plan view. Hereinafter, a “first metal pattern 50a” is defined as the first metal layer 50 after being etched as described above.

FIG. 5D is a partial cross-sectional view illustrating a process of etching away a portion of the lower transparent substrate using the etched first metal layer as a mask. Referring to FIG. 5D, a receiving groove 212 having a specific width and depth is formed by etching a portion of the lower transparent substrate 210 away using the first metal pattern 50a as a mask. The portion of the lower transparent substrate 210 is etched away for a selected distance in a direction substantially parallel to the upper surface of the lower transparent substrate 210 so that an undercut is formed under the sidewalls of the first metal pattern 50a, as illustrated in FIG. 5D. A hydrofluoric acid (HF) diluted with distilled water may be used as an etching solution in etching the lower transparent substrate 210.

FIG. 5E is a partial cross-sectional view illustrating a process of further etching the etched first metal layer in a horizontal direction. Referring to FIG. 5E, the first metal pattern 50a is further etched away a selected distance in a direction substantially parallel to the upper surface of the lower transparent substrate 210. In the exemplary embodiment illustrated, the first metal pattern 50a is etched away horizontally so that the undercut that was formed under the sidewalls of the first metal pattern 50a is eliminated.

Hereinafter, a “second metal pattern 50b” is defined as the first metal layer 50 after being further etched, as above, and a “protruding surface 214” of the lower transparent substrate 210 is defined as that portion of the upper surface of the lower transparent substrate 210 remaining after the above etching processes are complete, i.e., the portion of the protruding surface 214 in which the receiving groove 212 is not formed. By this definition, it may be seen that the second metal pattern 50b is disposed only on the protruding surface 214 of the lower transparent substrate 210.

FIG. 5F is a partial cross-sectional view illustrating a process of forming a second metal layer over the patterned photoresist layer 60 and the receiving groove 212. In FIG. 5F, a second metal layer 70 is formed over the entire surface of the substrate after the second metal pattern 50b is formed. The second metal layer 70 is thus formed over an upper surface of the patterned photoresist layer 60 and over the bottom surface of the receiving groove 212. The second metal layer 70 may be formed, for example, by a plasma chemical vapor deposition method or by a sputtering method.

The second metal layer 70 may also incorporate a triplex layer structure that is the same as that of the first metal layer 50. Thus, for example, the bottom layer 72 of the second metal layer 70 may include molybdenum-tungsten (MoW), the middle layer 74 may include titanium (Ti), and the top layer 76 may include nickel (Ni).

Hereinafter, a “third metal pattern 70a” is defined as that portion of the second metal layer 70 that is formed on the bottom surface of the receiving groove 212.

FIG. 5G is a partial cross-sectional view illustrating a process of removing the patterned photoresist layer. Referring to FIG. 5C; the patterned photoresist layer 60 is removed so that only the third metal pattern 70a of the second metal layer 70 remains. That is, all of the second metal layer 70 formed on the patterned photoresist layer 60 is removed, together with the underlying patterned photoresist layer 60, such that only the third metal pattern 70a remains on the bottom surface if the receiving groove 212, as illustrated in FIG. 5G.

FIG. 5H is a partial cross-sectional view illustrating a process of forming an electron-emitting part on the first and the second metal layers. Referring to FIG. 5H, an electron-emitting part 240 is formed on the second metal pattern 50b and the third metal pattern 70a after the patterned photoresist layer 60 is removed, as described above. Each of the nickel (Ni) layers of the second metal pattern 50b and the third metal pattern 70a are grown in a di-reaction substantially perpendicular to the upper surface of the lower transparent substrate 210, so that the grown nickel (Ni) layers form the electron-emitting part 240.

In one exemplary embodiment, the nickel (Ni) layers are partially etched to form conductive balls thereon that are spaced apart from each other, and then grown in a direction substantially perpendicular to the upper surface of the lower transparent substrate 210 by using the conductive balls as seed, so that the grown nickel (Ni) layers form electron emitting protrusions (not illustrated in FIG. 5H) of the type illustrated in FIG. 3. The electron emitting protrusions may each comprise a carbon nanotube. For example, in one exemplary embodiment, the vertical growth of the electron emitting protrusions is effected by plasma chemical vapor deposition equipment using, for example, methane gas (C2H2) or ammonia gas (NH3) as a reaction gas.

In one possible exemplary embodiment, the growth of the Nickel (Ni) layers may be omitted from respective portions of the molybdenum-tungsten (MoW) and titanium (Ti) layers of the second and third metal patterns 50b and 70a, and these portions may form the first and second electrode parts 220 and 230, respectively, as described above. A lower substrate 200 of a field emission display may thus be manufactured in accordance with the process described above.

Next, and referring again to FIGS. 1 and 2, an upper substrate 100 of the backlight is formed. As described above, the upper substrate 100 includes an upper transparent substrate 110, a transparent electrode 120 formed on the upper transparent substrate 110, and a fluorescent part 130 formed on the transparent electrode 120. The upper substrate 100 is manufactured by more conventional processes that are different from those by which the lower substrate 200 is manufactured. When completed, the upper substrate and the lower substrate 200 are combined to form a completed field emission backlight 300.

In accordance with the exemplary embodiments of the field emission backlight described above, the gap between the first and the second electrode parts 220 and 230 can be substantially reduced relative to that required in a conventional field emission backlight because the receiving groove 212 is formed by etching a portion of the lower transparent substrate 210, and the second electrode part 230 is formed on the bottom surface of the receiving groove 212, thus providing a vertical separation between the two electrode parts that enables the horizontal separation between them to be reduced while maintaining the requisite minimum separation therebetween.

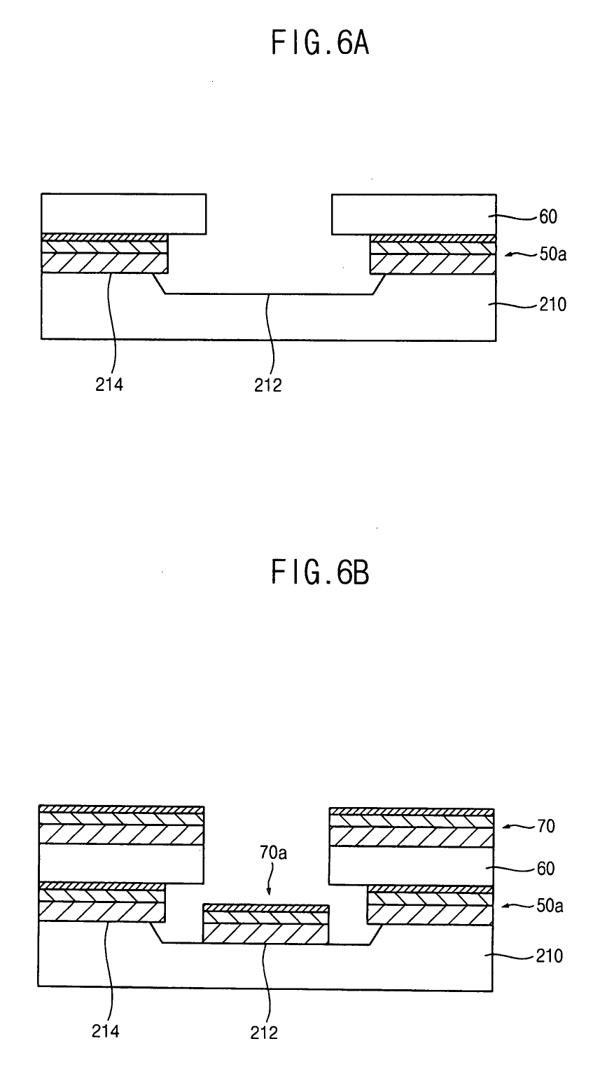

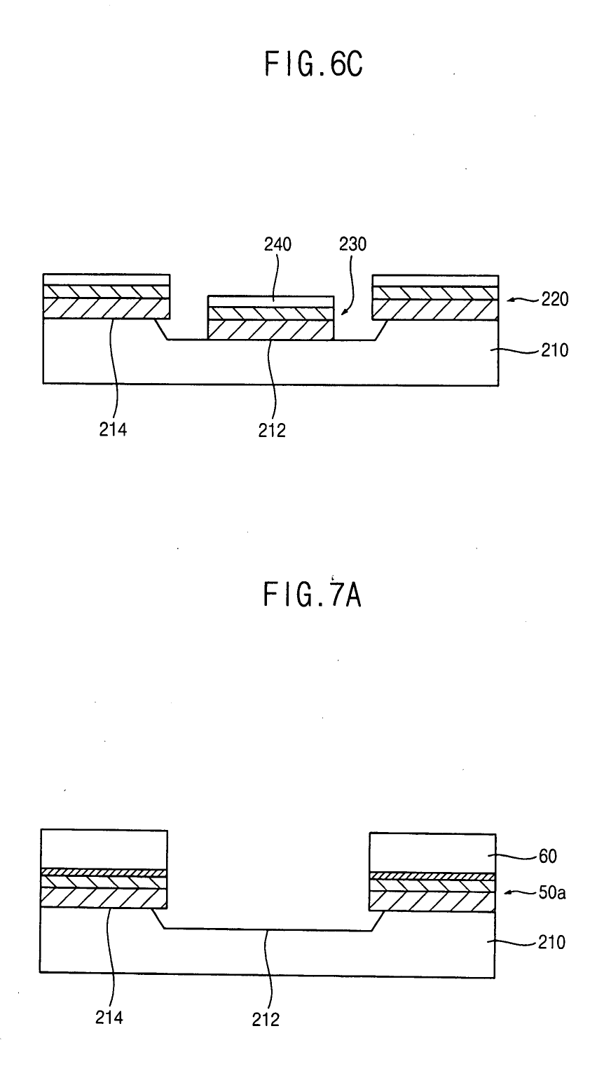

FIGS. 6A to 6C are partial cross-sectional views respectively illustrating a second exemplary embodiment of a method for manufacturing a field emission backlight in accordance with the present invention. First, and referring back to FIGS. 5A and 5B, a first metal layer 50 is formed on an upper surface of a lower transparent substrate 210. The first metal layer 50 may have a triplex layer structure, for example, a molybdenum-tungsten (MoW) bottom layer, a titanium (Ti) middle layer and a nickel (Ni) top layer. A photoresist layer 60 is then formed over the entire uppers surface of the first metal layer 50, and the photoresist layer 60 is patterned using a photo process and a mask.

FIG. 6A is a cross-sectional view illustrating the etching of the first metal layer and the lower transparent substrate. In FIG. 6A, a portion of the first metal layer 50 is etched so as to form respective undercuts below each of the photo resist layer and the first metal layer using the patterned photoresist layer 60 as a mask. Hereinafter, a “first metal pattern 50a” is defined as the first metal layer 50 after being etched as described. For example, a portion of the first metal layer 50 may be removed by a metal etching solution so that an undercut is formed below the margin of the patterned photoresist layer 60. The metal etching solution etches the first metal layer 50 in a direction substantially perpendicular to the upper surface of the lower transparent substrate 210, and also etches the first metal layer 50 in a direction substantially parallel to the upper surface of the lower transparent substrate 210 to form the undercut.

After the metal layer 50 is etched to form the first metal pattern 50a, a portion of the lower transparent substrate 210 is etched using the first metal pattern 50a as a mask, so that a receiving groove 212 having a selected depth and tapering sidewalls is formed in the lower substrate. A hydrofluoric acid (HF) diluted with distilled water may be used as the etching solution in etching the lower transparent substrate. As above, when a “protruding surface 214” of the substrate is defined to be the portion of the upper surface of the lower transparent substrate 210 in which the receiving groove 212 is not formed, the first metal pattern 50a is formed on only the protruding surface 214 of the lower transparent substrate 210.

FIG. 6B is a partial cross-sectional view illustrating the formation of a second metal layer on the patterned photoresist layer and the receiving groove. In FIG. 6B, a second metal layer 70 is formed over the entire upper surface of the substrate after the receiving groove 212 has been formed therein, as described above. The second metal layer 70 is thus formed over the upper surface of the patterned photoresist layer 60 and on the bottom surface of the receiving groove 212. The second metal layer 70 may have a triplex layer structure that is the same as that of the first metal layer 50. Hereinafter, a second metal pattern 70a is defined as that portion of the second metal layer 70 that is formed on the bottom surface of the receiving groove 212.

FIG. 6C is a partial cross-sectional view illustrating the removal of the patterned photoresist layer and the formation of an electron-emitting part on the lower substrate. Referring to FIG. 6C, the patterned photoresist layer 60 is first removed so that only the second metal pattern 70a remains. The second metal layer 70 formed on the patterned photoresist layer 60 is removed, along with the patterned photoresist layer 60, so that only the second metal pattern 70a remains.

An electron-emitting part 240 is then formed on the first and second metal patterns 50a and 70a. In the exemplary embodiment illustrated, each of the nickel (Ni) layers of the first and second metal patterns 50a and 70a is grown in a direction substantially perpendicular to the upper surface of the lower transparent substrate 210, so that the grown nickel (Ni) layers form the electron-emitting part 240.

As in the first embodiment above, the growth of the electron emitting nickel layers may be omitted from respective portions of the molybdenum-tungsten (MoW) and titanium (Ti) layers of the second and third metal patterns 50b and 70a, and these portions may form the first and second electrode parts 220 and 230, respectively, as described above. A lower substrate 200 of a field emission display may thus be manufactured in accordance with the process described above. Then, the lower substrate 200 manufactured by the above-described process and an upper substrate 100 manufactured through other processes are combined to form a field emission backlight 300.

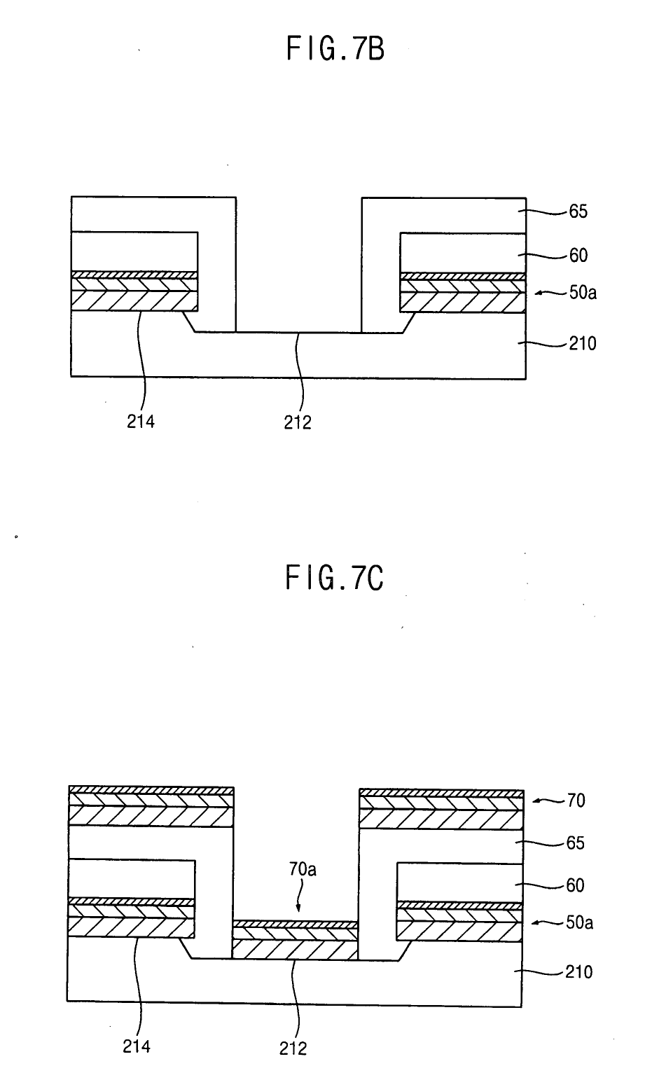

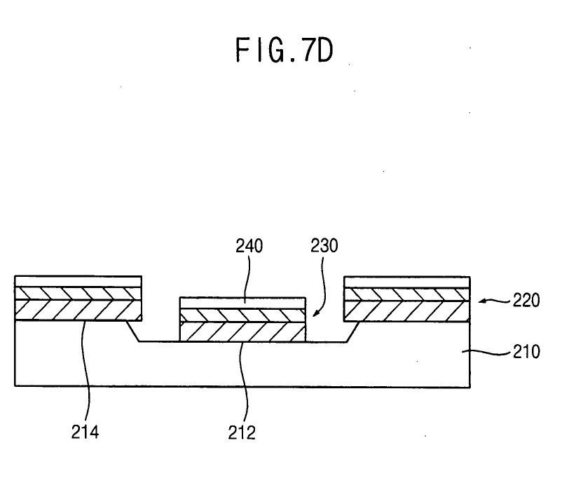

FIGS. 7A to 7D are partial cross-sectional views respectively illustrating sequential processes of a third exemplary embodiment of a method for manufacturing a field emission backlight in accordance with the present invention.

First, referring back to FIGS. 5A, 5B and 5C, a first metal layer 50 is formed on an upper surface of a lower transparent substrate 210. As above, the first metal layer 50 may comprise a triplex layer structure, with, e.g., a molybdenum-tungsten (MoW) bottom layer, a titanium (Ti) middle layer, and a nickel (Ni) top layer. A first photoresist layer 60 is formed over the entire upper surface of the first metal layer 50, and the first photoresist layer 60 is patterned with a photo process using a mask.

A portion of the first metal layer 50 is then etched using the patterned first photoresist layer 60 as a mask so that a first metal pattern 50a is formed. In this etching process, the first metal layer 50 is etched in a direction substantially perpendicular to the upper surface of the lower transparent substrate 210. Accordingly, the etched first metal layer 50 has vertical side-walls and substantially the same shape as the patterned first photoresist layer 60 when viewed in a plan view.

FIG. 7A is a partial cross-sectional view illustrating the etching away of a portion of the lower transparent substrate 210 using the first metal layer 50a as a mask. In FIG. 7A, a receiving groove 212 having a specific depth is formed by etching a portion of the lower transparent substrate 210 using the first metal pattern 50a as a mask. As in the above embodiments, hydrofluoric acid (HF) diluted with distilled water may be used as an etching solution in etching the lower transparent substrate, and as above, when a “protruding surface 214” of the lower substrate 210 is defined as the portion of the upper surface of the lower transparent substrate 210 in which the receiving groove 212 is not formed, the first metal pattern 50a is disposed on only the protruding surface 214 of the lower transparent substrate 210.

FIG. 7B is a partial cross-sectional view illustrating the formation of a second photoresist layer patterned so as to wrap down along the sidewalls of the first metal layer and the first photoresist layer. Referring to FIG. 7B, a second photoresist layer 65 is first formed so that it completely covers the first metal pattern 50a and the first photoresist layer 60. The second photoresist layer 65 is then patterned by means of a photo process so that the second photoresist layer 65 wraps down over the sidewalls of the first metal pattern 50a and the first photoresist layer 60, and such that the patterned second photoresist layer 65 contacts not only the upper surface of the first photoresist layer 60, but also the sidewalls of both the first metal pattern 50a and the first photoresist layer 60.

FIG. 7C is a partial cross-sectional view illustrating forming a second metal layer on the patterned second photoresist layer and on the receiving groove 212. In FIG. 7C, a second metal layer 70 is formed over the entire upper surface of the substrate, such that the second metal layer 70 is disposed on both an upper surface of the patterned second photoresist layer 65 and on the bottom surface of the receiving groove 212. As above, the second metal layer 70 may comprise a triplex layer structure. Hereinafter, a second metal pattern 70a is defined as a portion of the second metal layer 70 that is thus formed on the bottom surface of the receiving groove 212.

FIG. 7D is a partial cross-sectional view illustrating the formation of an electron-emitting part on the substrate after the patterned first and second photoresist layers have been removed therefrom. Referring to FIG. 7D, the patterned first and second photoresist layers 60 and 65 are removed so that only the second metal pattern 70a remains. The second metal layer 70 formed on the upper surface of the patterned second photoresist layer 65 may be removed, together with the patterned first and second photoresist layers 60 and 65, such that only the second metal pattern 70a remains on the bottom surface of the receiving groove 212.

An electron-emitting part 240 is then formed on the first and second metal patterns 50a and 70a. For example, as described above, each of the nickel (Ni) layers of the first metal pattern 50a and the second metal pattern 70a are grown in a direction substantially perpendicular to the upper surface of the lower transparent substrate 210, so that the grown nickel (Ni) layers form the electron-emitting part 240.

As in the above embodiments, the growth of the electron emitting nickel layers may be omitted from respective portions of the molybdenum-tungsten (MoW) and titanium (Ti) layers of the second and third metal patterns 50b and 70a, and these portions may form the first and second electrode parts 220 and 230, respectively, as described above. The lower substrate 200 manufactured in accordance with the process described above is then combined with an upper substrate 100 manufactured through other processes to form a field emission backlight 300.

In accordance with the exemplary embodiments of the present invention described above, the gap between the first and second electrode parts can be substantially reduced relative to that required in a conventional field emission backlight because a receiving groove is formed by etching a portion of the lower transparent substrate and the second electrode part 230 is formed at the bottom surface of the receiving groove, thereby providing a vertical separation between the two electrode parts that enables the horizontal separation between them to be reduced, relative to that of conventional field emission backlights, while maintaining the requisite minimum separation between them. This, in turn, enables the level of the voltage applied between the first and the second electrode parts to be reduced, thereby enabling the cost of the components of a driving circuit to be reduced and resulting in an overall reduction in the manufacturing cost of a field emission backlight.

By now, those of skill in this art will appreciate that many modifications, substitutions and variations can be made in and to the field emission backlights and the methods for making them of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. A field emission backlight comprising:
an upper substrate, including:
a upper transparent substrate;
a transparent electrode formed on the upper transparent substrate; and,
a fluorescent part formed on the transparent electrode; and,
a lower substrate, including:
a lower transparent substrate having a receiving groove formed in an upper surface thereof, the upper surface being disposed in facing opposition to the upper substrate;
a first electrode part formed on the upper surface of the lower transparent substrate;
a second electrode part formed on a bottom surface of the receiving groove, the second electrode part being spaced apart from the first electrode part by a selected distance; and
an electron-emitting part formed on an upper surface of at least one of the first and second electrode parts, the electron-emitting part being operative to emit electrons in response to the generation of an electric field between the first and second electrode parts.

2. The field emission backlight of claim 1, wherein:
the first electrode part comprises a plurality of elongated first branch electrodes extending in a first direction and disposed substantially parallel with each other; and,
the second electrode part comprises a plurality of elongated second branch electrodes extending in the first direction and interleaved between the first branch electrodes.

3. The field emission backlight of claim 2, wherein:
the first electrode part further comprises an elongated first body electrode disposed at a first side of the lower substrate, the first body electrode being electrically connected to the first branch electrodes and extending generally perpendicular thereto; and,
the second electrode part further comprises a second body electrode disposed at a second side of the lower substrate, the second body electrode being electrically connected to the second branch electrodes and extending generally perpendicular thereto.

4. The field emission backlight of claim 2, wherein the first and second branch electrodes have a gap between them, and wherein the gap is in a range of from about 5 μm to about 15 μm.

5. The field emission backlight of claim 1, wherein an alternating current voltage is applied between the first electrode part and the second electrode part.

6. The field emission backlight of claim 5, wherein the alternating current voltage is in a range of from about 10 V to about 100 V.

7. The field emission backlight of claim 6, wherein a direct current voltage in a range of from about 5 kV to about 15 kV is applied to the transparent electrode.

8. The field emission backlight of claim 1, wherein the electron-emitting part comprises a carbon nanotube.

9. The field emission backlight of claim 8, wherein the electron-emitting part comprises a plurality of electron emitting protrusions protruding substantially perpendicularly to the first and the second electrode parts.

10. The field emission backlight of claim 1, further comprising a reflecting part formed on a lower surface of the lower transparent substrate.

11. The field emission backlight of claim 10, wherein the reflecting part comprises a metal, and wherein a ground voltage is applied to the reflecting part.

12. A display apparatus, comprising:
a field emission backlight for producing visible light, including:
an upper substrate, including:
an upper transparent substrate;
a transparent electrode formed on the upper transparent substrate; and,
a fluorescent part formed on the transparent electrode; and,
a lower substrate, including:
a lower transparent substrate having a receiving groove formed in an upper surface thereof, the upper surface being disposed in facing opposition to the upper substrate;
a first electrode part formed on the upper surface of the lower transparent substrate;
a second electrode part formed on a bottom surface of the receiving groove, the second electrode part being spaced apart from the first electrode part by a selected distance; and,
an electron-emitting part formed on an upper surface of at least one of the first and second electrode parts and operative to emit electrons in response to the generation of an electric field between the first and second electrode parts; and,
a display panel disposed above the field emission backlight, the display panel being operative to display an image using the light produced by the backlight.

13. A method of manufacturing a field emission backlight, the method comprising:
forming a first metal layer on an upper surface of a lower transparent substrate;
forming and patterning a first photoresist layer on the first metal layer;
etching a portion of the first metal layer using the patterned first photoresist layer as a mask;
forming a receiving groove by etching a portion of the lower transparent substrate;
forming a second metal layer on the patterned first photoresist layer and a bottom surface of the receiving groove;
removing the patterned first photoresist layer;
forming an electron-emitting part on the first and the second metal layers to form a lower substrate;
forming an upper substrate, including an upper transparent substrate, a transparent electrode formed on the upper transparent substrate, and a fluorescent part formed on the transparent electrode; and,
combining the upper substrate with the lower substrate.

14. The method of claim 13, wherein forming the receiving groove comprises:
etching a portion of the lower transparent substrate using the etched first metal layer as a mask; and,
further etching the etched first metal layer a selected length in a direction substantially parallel to the upper surface of the lower transparent substrate.

15. The method of claim 13, wherein etching a portion of the first metal layer comprises etching the first metal layer through the patterned first photoresist layer in a direction substantially perpendicular to the upper surface of the lower transparent substrate, and further etching the first metal layer in a direction substantially parallel to the upper surface of the lower transparent substrate.

16. The method of claim 13,
wherein forming the receiving groove comprises etching a portion of the lower transparent substrate using the etched first metal layer as a mask, and forming a second photoresist layer patterned so as to wrap down along sidewalls of the first metal layer and the first photoresist layer,
wherein forming the second metal layer comprises forming the second metal layer on the patterned second photoresist layer and the bottom surface of the receiving groove, and,
wherein removing the patterned first photoresist layer comprises removing both the patterned first photoresist layer and the patterned second photoresist layer.

17. The method of claim 13, wherein each of the first and second metal layers incorporates a triplex layer structure.

18. The method of claim 17, wherein each of the first and second metal layers comprises a molybdenum-tungsten (MoW) layer, a titanium (Ti) layer, and a nickel (Ni) layer.

19. The method of claim 18, wherein each of the nickel (Ni) layers of the first and second metal layers is grown in a direction substantially perpendicular to the upper surface of the lower transparent substrate, such that the grown nickel (Ni) layers form the electronemitting part.

20. The method of claim 13, wherein a hydrofluoric acid (HF) diluted with distilled water is used as an etching solution in the etching of the lower transparent substrate.
